(19) United States
(12) Patent Application Publication
(10) Pub. No.: US 2026/0350058 A1
(43) Pub. Date: Nov. 5, 2026

(54) Iterative Prompting for Quantifying Uncertainty in Language Models

(71) Applicant: Oracle International Corporation, Redwood Shores, CA (US)

(72) Inventor: Mohammadtaher Safarzadeh, New York City, NY (US)

(73) Assignee: Oracle International Corporation, Redwood Shores, CA (US)

(21) Appl. No.: 19/659,550

(22) Filed: Apr. 27, 2026

Related U.S. Application Data
(60) Provisional application No. 63/799,296, filed on May 2, 2025.

(51) Int. Cl. G06F 16/3329; G06F 16/334

(52) U.S. Cl. CPC G06F 16/33295; G06F 16/3347

(57) ABSTRACT

Techniques for evaluating the behavior of a language model (LM) by iteratively prompting an LM to quantify uncertainty in the LM are disclosed. A system queries an LM with a prompt to form response chains to iterate over, calculates a convergence metric using the refined response chains generated during the iterations, and determines the reliability of the LM based on the convergence metric. The system iterates over the response chains to generate refined response chains. The system calculates the convergence metric by computing variances of the refined response chains and generating the convergence metric based on the variances. The system compares the convergence metric to a threshold to determine a convergence state of the response chains and classifies the reliability of the LM based on the convergence state; the LM is either reliable when the response chains converge or unreliable when the response chains do not converge.

### INCORPORATION BY REFERENCE; DISCLAIMER

Each of the following applications and any parent patent applications (provisionals, non-provisionals, international, and foreign) to which this application claims priority to, directly or indirectly, are hereby incorporated by reference in their entirety to the same extent as if fully and explicitly recited herein. Any incorporation by reference is limited such that no subject matter is incorporated that is contrary to the explicit disclosure herein. The applications being incorporated by reference include at least: U.S. Application No. 63/799,296 filed on May 2, 2025.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to evaluating the behavior of language models (LMs). In particular, the present disclosure relates to quantifying uncertainty to evaluate the behavior of LMs.

### BACKGROUND

Uncertainty quantification is a critical aspect of understanding and evaluating the behavior of LMs. Language models are often integrated into broader machine learning (ML) pipelines that handle various processes, such as data ingestion, preprocessing, model selection and training. Additionally, LMs are often integrated into inference workflows that transform raw model probabilities into user-consumable predictions. For instance, LMs built on transformer architectures process input text (e.g., natural language) by tokenizing the inputs into embeddings and applying self-attention across multiple layers to capture long-range dependencies and generate fluent outputs. Generative models inherently leverage stochasticity to mimic and diversify from training data, so identical prompts in the inputs to a language model (LM) can yield different outputs generated by the LM, thereby creating a trade-off between creativity and predictability of the LM.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the FIGURES of the accompanying drawings. It should be noted that references to “an” or “one” embodiment in this disclosure are not necessarily to the same embodiment, and they mean at least one. In the drawings:

FIG. 1A illustrates a system in accordance with one or more embodiments;

FIG. 1B illustrates a system architecture in accordance with one or more embodiments;

FIG. 2 illustrates an example set of operations for quantifying uncertainty in language models (LMs) in accordance with one or more embodiments;

FIG. 3 illustrates an example set of operations for quantifying uncertainty in LMs in accordance with one or more embodiments;

FIG. 4 illustrates a machine learning (ML) engine in accordance with one or more embodiments;

FIG. 5 illustrates the operation of an ML engine in one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. LANGUAGE MODEL UNCERTAINTY QUANTIFICATION ARCHITECTURE
3. QUANTIFYING UNCERTAINTY IN LANGUAGE MODELS
4. EXAMPLE EMBODIMENT
5. MACHINE LEARNING ARCHITECTURE
6. GENERATIVE MODELS
7. PRACTICAL APPLICATIONS, ADVANTAGES, AND IMPROVEMENTS
8. COMPUTER NETWORKS AND CLOUD NETWORKS
9. HARDWARE OVERVIEW
10. MISCELLANEOUS; EXTENSIONS

### 1. General Overview

Uncertainty quantification is a critical aspect of understanding and evaluating the behavior of LMs. Language models are often integrated into broader ML pipelines and inference workflows that transform raw model probabilities into user-consumable predictions. However, LMs often produce inconsistent or unstable outputs, especially on ambiguous or unfamiliar topics. For instance, generative models inherently leverage stochasticity to mimic and diversify from training data, so identical prompts in the inputs to an LM can yield different outputs generated by the LM, thereby creating a trade-off between creativity and predictability of the LM. This variability poses a challenge when organizations require stable, reliable answers, particularly in high-stakes or compliance-sensitive contexts. Therefore, enterprises need a systematic, offline method to measure when LM outputs are reliable or risky to decide where additional safeguards or retraining are needed in the pipelines and workflows integrating the LM, especially before deployments into production environments. For example, during the inference phase, probability distributions over candidate outputs may indicate ambiguity when no class is clearly dominant, prompting the need for calibrated ways to detect and respond to low-confidence situations (e.g., deferring to humans or applying stricter thresholds). Current approaches addressing inconsistent responses output by an LM rely on consistency verification, but such verification processes involve multiple queries to the LM. In particular, current approaches leverage voting mechanisms using aggregation or selection heuristics that lack a rigorous, quantitative mechanism to assess convergence and uncertainty. Thus, there is no efficient way to determine when outputs have stabilized across iterations or prompts, especially for ambiguous or poorly known topics. The present disclosure relates to quantifying uncertainty to evaluate the behavior of LMs and particularly to offline uncertainty quantification and convergence diagnostics using iterative prompting, embedding-based variance analysis both within-chain and between-chain, and Gelman-Rubin-style metrics to assess response stability and reliability of LMs.

In particular, the present disclosure provides a refined analysis of consistency testing by drawing an analogy between iterative response generation in LMs and Markov Chain Monte Carlo (MCMC) methods. The initial responses from the LM are framed as independent walkers in a high-dimensional response space, and subsequent refinements prompted by the user are interpreted as analogous to MCMC proposal functions. Unlike traditional MCMC, where convergence is guided by an acceptance-rejection criterion, the iterations in this process are retained, thereby forming a sequence of evolving responses. To analyze these dynamics, embeddings of the responses are computed, and the variance of cosine similarity across iterations is evaluated. As a result, the evolution of variance offers a lens into the LM's understanding and certainty. In particular, variance increases due to exploration for ambiguous topics, whereas variance decreases as responses converge for familiar topics. Such behavior parallels MCMC convergence diagnostics, such as the Gelman-Rubin statistic, and underscores the utility of iterative prompting as a diagnostic framework. By refining consistency tests, the present disclosure offers a novel perspective on response diversity, convergence, and the diagnostic evaluation of generative models.

One or more embodiments query an LM with a prompt to form response chains to iterate over, calculate a convergence metric using the refined response chains generated during the iterations, and determine the reliability of the LM based on the convergence metric. Initially, a system accesses a specification, including the prompt for the LM and iteration parameters for the iterations over the response chains. The system queries the LM with the prompt from the specification to generate responses to the prompt. The system generates response chains by initializing a response chain for each of the responses the LM generated based on the prompt. The system iterates over the response chains according to the iteration parameters to generate refined response chains and transforms the refined response chains into vectors in an embedding space. The system calculates the convergence metric by computing between-chain variances and within-chain variances of the refined response chains and calculating the convergence metric based on the variances. The system compares the convergence metric to at least one threshold to determine the convergence state of the response chains and classifies the reliability of the LM based on the convergence state. If the system determines the response chains converge, then the LM is reliable; if the system determines the response chains do not converge, then the LM is not reliable. In response, the system outputs a reliability indicator for the LM based on the convergence state and further initiates a safeguard action when the convergence state is non-converged.

One or more embodiments described in this Specification and/or recited in the claims may not be included in this General Overview section.

### 2. Language Model Uncertainty Quantification Architecture

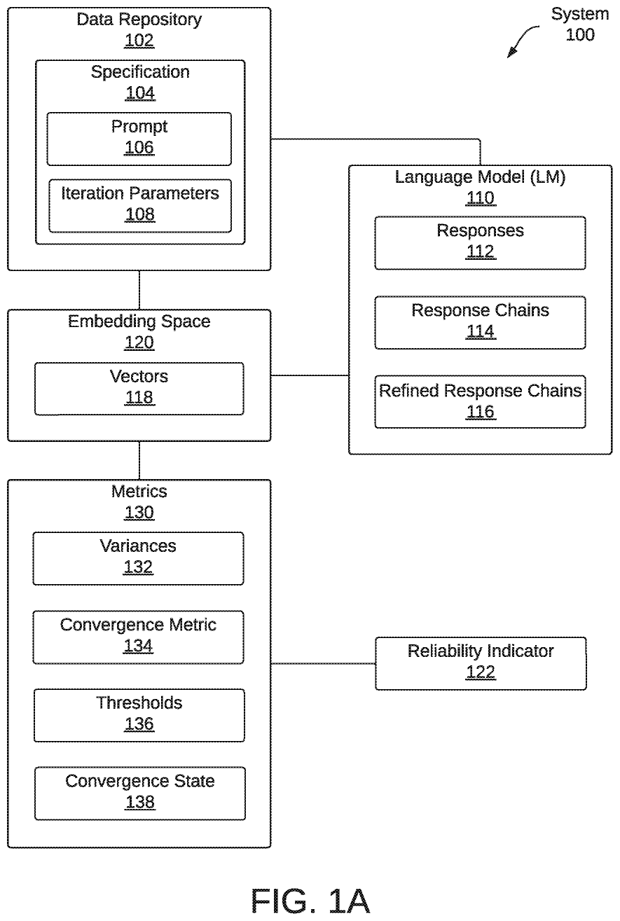

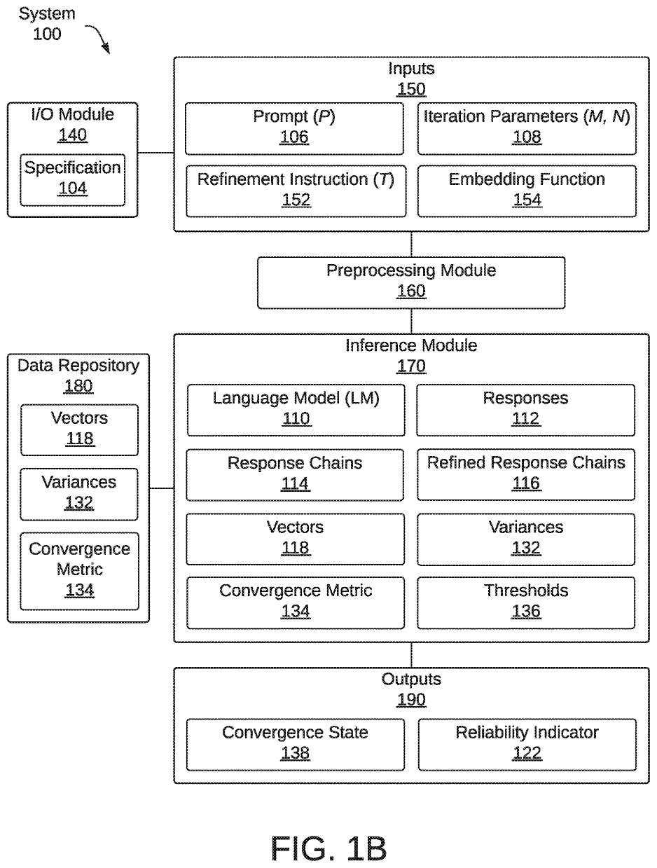

FIG. 1A illustrates a system 100 in accordance with one or more embodiments. As illustrated in FIG. 1A, system 100 includes data repository 102, language model 110, embedding space 120, metrics 130, and reliability indicator 122. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

In one or more embodiments, a data repository 102 is any type of storage unit and/or device (e.g., a file system, database, collection of tables, or any other storage mechanism) for storing data. Furthermore, a data repository 102 may include multiple different storage units and/or devices. The multiple different storage units and/or devices may or may not be of the same type or located at the same physical site. Furthermore, a data repository 102 may be implemented or executed on the same computing system as language model 110 and embedding space 120. Additionally, or alternatively, a data repository 102 may be implemented or executed on a computing system separate from language model 110 and embedding space 120. The data repository 102 may be communicatively coupled to language model 110 and embedding space 120 via a direct connection or via a network. Furthermore, data sets illustrated within the data repository 102 may be implemented across any components within the system 100 in a decentralized and/or distributed manner. The data sets are illustrated within the data repository 102 for purposes of clarity and explanation.

In one or more embodiments, the data repository 102 stores a specification 104. The specification 104 includes a prompt 106 and iteration parameters 108. The specification 104 may be a plan with instructions for the system 100, such as a document, structured language (e.g., JSON, XML, or HTML), source code, or other input item with a test or procedure to execute. The prompt 106 is the topic or domain under test (denoted as P) in the system 100 such as a query for an LM in the system 100. The iteration parameters 108 include a number of response chains (M) and a number of iterations (N) per response chain for the system 100 to refer to and provide as inputs during execution. The specification 104 may include other inputs, such as the target LM (ƒ_{LM}) under evaluation by the system 100, a refinement instruction (T) to apply during the iterations N, an embedding function (e.g., SentenceTransformer), and/or a cosine similarity for semantic comparison. In some embodiments, the specification 104 includes a plurality of prompts, and the prompt 106 is a prompt selected from among the plurality of prompts.

In one or more embodiments, a language model 110 is the target LM under evaluation by the system 100. The language model 110 is the LM that the system 100 is quantifying the uncertainty of by using the operations of the present disclosure (i.e., the target LM (ƒ_{LM}) under evaluation by the system 100). The language model 110 produces responses 112 upon input of the prompt 106 into the language model 110. The responses 112 are the initial responses

$$( {r}_{i}^{( 0 )} ∈ \{ 1 , ... , M \} )$$

generated by querying the language model 110 with the prompt 106 and applying the iteration parameters 108, and the response chains 114

$$( {r}_{1}^{( 0 )} , {r}_{2}^{( 0 )} , ... , {r}_{M}^{( 0 )} )$$

are initialized based on the responses 112. The number of response chains 114 are identified in the iteration parameters 108 as the number of response chains (M). The response chains 114 include response chains that are independent from each other. The initial batch of responses 112 generated by the language model 110 corresponds to independent response chains 114 since a response chain is initialized for each response of the responses 112 to create the response chains 114. Iteratively prompting the language model 110 with the prompt 106 and the iteration parameters 108 produces refined response chains 116

$$( {r}_{i}^{( t )} )$$

as the language model 110 generates new responses for each response chain 114(i) at each iteration (t) of the number of iterations (N) identified in the iteration parameters 108, where a new response is conditioned on the current state.

In one or more embodiments, an embedding space 120 stores vectors 118. The vectors 118 are created when the refined response chains 116 are transformed into vector representations. The refined response chains 116 are converted to embeddings, resulting in the vectors 118 in the embedding space 120. The embeddings are numerical vector representations (i.e., the vectors 118) of the refined response chains 116 that capture semantic relationships in the new responses (i.e., the refined response chains 116). The vectors 118 place similar or related responses in the refined response chains 116 closer together in the embedding space 120. In some embodiments, the embedding space 120 is included in a storage device, such as the data repository 102, for storing the vectors 118.

In one or more embodiments, metrics 130 include variances 132, convergence metric 134, thresholds 136, and convergence state 138. The variances 132 may include a plurality of between-chain variances and a plurality of within-chain variances. Between-chain variances are computations of the pairwise distances (e.g., the cosine-distance variance) across the response chains 114 where the response chains 114 are represented by the vectors 118. For instance, the between variances can be the computations of the cosine distance between the vectors 118. Within-chain variances are computations of the pairwise distances (e.g., the cosine-distance variance) within each response chain across the iterations (N) over time within each response chain where the response chains 114 are represented by the vectors 118. The convergence metric 134 is a value calculated using the variances 132 to diagnose the convergence of the response chains 114. The thresholds 136 include at least one threshold for interpreting the convergence metric 134. Interpreting the convergence metric 134 using a comparison with thresholds 136 allows for determining the convergence state 138 of the response chains 114. The convergence metric 134 indicates stability of the response chains 114 over the iterations when the convergence metric 134 meets a value from the thresholds 136. The convergence metric 134 indicates instability of the response chains 114 over the iterations when the convergence metric 134 exceeds a value from the thresholds 136. For instance, when the convergence metric 134 is generated using the Gelman-Rubin convergence diagnostic, the thresholds 136 may be 1 and 1.1, so the response chains 114 converge when the convergence metric 134 is approximately 1 and the response chains 114 do not converge when the convergence metric 134 is greater than 1.1. The convergence state 138 is a classification of the response chains 114 as converged or non-converged. For instance, the convergence state 138 includes converged responses in the response chains 114 or non-converged responses in the response chains 114. A converged convergence state 138 indicates stable and consistent responses in the response chains 114. A non-converged convergence state 138 indicates variable and inconsistent responses in the response chains 114. One or more of the metrics 130 may be stored in a storage device such as the data repository 102.

In one or more embodiments, a reliability indicator 122 is an identifier labeling the language model 110 as stable or risky based on the convergence state 138. The reliability indicator 122 may include a time series of the variances 132 (e.g., the between-chain variances and the within-chain variances) and the convergence metric 134. The reliability indicator 122 may include a convergence label or a domain trust profile associating the prompt 106 with a reliability classification based on the convergence metric 134 and the convergence state 138. A domain-specific trust profile may include a mapping from the prompts or topics tested to one or more reliability classifications derived from the convergence state 138 and the convergence metric 134. The reliability indicator 122 may be a convergence label that states whether the response chains 114 are converged or non-converged, as indicated by the convergence state 138. The reliability indicator 122 may be a message or log that can be stored in a storage device such as the data repository 102. The reliability indicator 122 may be in the form of a structured response format (e.g., a JSON, XML, or HTML) configured for output via an application programming interface (API) of the system 100.

FIG. 1B illustrates a system architecture in accordance with one or more embodiments. As illustrated in FIG. 1B, system 100 includes I/O module 140, inputs 150, preprocessing module 160, inference module 170, data repository 180, and outputs 190. In one or more embodiments, the system 100 may include more or fewer components than the components illustrated in FIG. 1B. The components illustrated in FIG. 1B may be local to or remote from each other. The components illustrated in FIG. 1B may be implemented in software and/or hardware. Each component may be distributed over multiple applications and/or machines. Multiple components may be combined into one application and/or machine. Operations described with respect to one component may instead be performed by another component.

In the example of FIG. 1B, the system is positioned within an ML architecture that may include data ingestion, I/O, and preprocessing, model selection, training with overfitting controls, evaluation and tuning with feedback integration and versioning, and inference with post-processing and confidence handling. This ML architecture enables consistent, secure, API-driven integration of the method for determining the reliability of the LM based on convergence of the LM's responses into enterprise workflows. In some embodiments, the ML architecture can be installed as an internal mechanism for the LM for constant evaluation of the reliability of the LM on certain topics.

In one or more embodiments, an I/O module 140 is configured to receive the specification 104. The I/O module 140 also receives datasets and requests, validates the inputs (e.g., the specification 104, datasets, and requests), formats inputs and outputs, and generates outputs to components of the system 100 with secure transfer or encryption. The I/O module 140 ensures inference-time preprocessing matches training-time formats for consistency. In one or more embodiments, inputs 150 include the prompt 106, the iteration parameters 108, a refinement instruction 152, and an embedding function 154. The inputs 150 are received by the I/O module 140. The refinement instruction 152 is a “think more” prompt (T) for the language model 110 during the N iterations for each of the response chains 114. The refinement instruction 152 acts as a proposal mechanism that provokes further elaboration of the immediately prior response in the response chain during the N iterations for a response chain of the response chains 114. The embedding function 154 is applied to compute the vectors 118 for the refined response chains 116 and embed the refined response chains 116 in the embedding space. An example embedding function 154 is a SentenceTransformer, and cosine similarity may also be included for semantic comparison. In some embodiments, the inputs 150 may include the target LM (ƒ_{LM}) under evaluation by the system 100, such as an identification of the language model 110 being the model whose uncertainty is being quantified by performing the operations. Outputs 190 include at least the convergence state 138 and the reliability indicator 122. In one or more embodiments, a preprocessing module 160 preprocesses the inputs 150 prior to use by the language model 110. Data preprocessing module with the preprocessing module 160 ensures inference-time formats match training-time formats for consistency. In some embodiments, an output handler securely distributes the outputs 190, including uncertainty quantification results for the language model 110 in the form of reports, visualizations, or data files using encryption and secure transfer protocols.

In one or more embodiments, an inference module 170 includes the language model 110 as well as the responses 112, response chains 114, refined response chains 116, vectors 118, variances 132, convergence metric 134, and thresholds 136 that are used and produced by the language model 110 during the uncertainty quantification process for the language model 110. The inference module 170 executes the iterations over the response chains 114 with the language model 110, computes the variances 132 and the convergence metric 134 using the thresholds 136, handles and communicates uncertainty via the convergence metric 134, and formats predictions for consumption, such as the convergence state 138 and the reliability indicator 122. In particular, inference module 170 executes the LM function ƒ_{LM} (the target LM under evaluation) and, where applicable, surfaces the uncertainty determination to users and systems, such as by post-processing outputs into visualizations or reports.

In some embodiments, the system 100 includes one or more modules for model selection, training, evaluation, and tuning. The one or more modules can host or select the target LM (e.g., language model 110), manage feedback, and maintain version control for changes such as when iterating on a plurality of LMs. For instance, an evaluation or tuning module can use offline diagnostics feedback to drive retraining, fine-tuning, or model selection adjustments.

In one or more embodiments, a data repository 180 is any type of storage unit and/or device (e.g., a file system, database, collection of tables, or any other storage mechanism) for storing data. Furthermore, a data repository 180 may include multiple different storage units and/or devices. The multiple different storage units and/or devices may or may not be of the same type or located at the same physical site. Furthermore, a data repository 180 may be implemented or executed on the same computing system as I/O module 140, preprocessing module 160, and inference module 170. Additionally, or alternatively, a data repository 180 may be implemented or executed on a computing system separate from as I/O module 140, preprocessing module 160, and inference module 170. The data repository 180 may be communicatively coupled to as I/O module 140, preprocessing module 160, and inference module 170 via a direct connection or via a network. Furthermore, data sets illustrated within the data repository 180 may be implemented across any components within the system 100 in a decentralized and/or distributed manner. The data sets are illustrated within the data repository 180 for purposes of clarity and explanation. In one or more embodiments, the data repository 180 stores the vectors 118, the variances 132, and the convergence metric 134 produced by the language model 110 during the operations for uncertainty quantification of the language model 110 using iterative prompting.

In some embodiments, the system 100 includes an API layer that includes RESTful endpoints (e.g., /submitData, /trainModel, /updateModel, /retrieveResults) with stateless HTTP/HTTPS semantics. Protocols and formats for APIs may include REST over HTTPS with JSON. Additionally, SOAP/WSDL or compact formats (e.g., Protocol Buffers/Avro) can be included in bandwidth-limited environments or WebSocket support can be included for real-time channels streaming diagnostics data (e.g., outputs 190) even when the core uncertainty quantification diagnostic is offline. For example, endpoints for job submission, status, and retrieval (e.g., /submitData or/submitDiagnosticRun), accepting the inputs 150, returning the metrics 130 or the outputs 190 (e.g., /retrieveResults), updating the language model 110 or quantifying the uncertainty of another LM in the system 100 (e.g., /updateModel) or training the language model 110 (e.g., /trainModel) can be part of the API layer.

In some embodiments, the system 100 includes microservice packaging that exposes the method for quantifying LM uncertainty using iterative prompting as an independently deployable microservice with inputs and outputs. The microservice packaging can be chained with other services (e.g., alerts, evaluation dashboards, retraining triggers) via HTTP, APIs, or a user interface that can validate datatype compatibility.

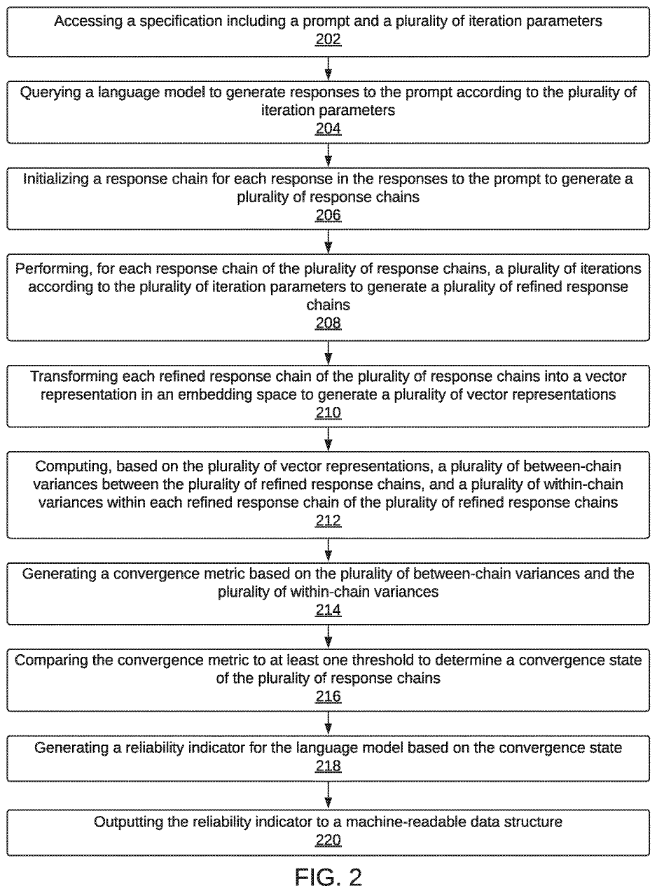

In one or more embodiments, system 100 refers to hardware and/or software configured to perform operations described herein for quantifying uncertainty in LMs. Examples of operations for quantifying uncertainty in LMs are described below with reference to FIG. 2.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Quantifying Uncertainty in Language Models

FIG. 2 illustrates an example set of operations for quantifying uncertainty in LMs in accordance with one or more embodiments. One or more operations cover the computerized generation of multiple iterative LM response “chains” with retention of refinements to the responses, conversion of the responses to vector representations, calculation of between-chain and within-chain dispersions over iterations, computation of a convergence metric from the dispersions, and emission of a machine-readable reliability indicator or trust profile. One or more operations illustrated in FIG. 2 may be modified, rearranged, or omitted. Accordingly, the particular sequence of operations illustrated in FIG. 2 should not be construed as limiting the scope of one or more embodiments.

An analogy can be drawn between the iterative nature of LM prompting and Markov Chain Monte Carlo (MCMC) methods, allowing tools used for probabilistic modeling to be applied to analyzing and quantifying uncertainty in LM responses. MCMC methods construct Markov chains that converge to a target distribution to enable efficient sampling from complex spaces. Convergence diagnostics can be used to evaluate if chains have mixed well and provide reliable estimates of the target distribution. In the present disclosure, the variance-based metrics from MCMC diagnostics are applied to LM responses, evaluating the stability and reliability of the LM responses by using iterative prompting to quantify uncertainty in the LM.

In an embodiment, the system accesses a specification that includes a prompt and a plurality of iteration parameters (Operation 202). The system may receive a specification to access. The system may receive a specification by receiving the specification via an interface in the system where a user inputs the specification to use, the specification including the prompt (P) and the iteration parameters to execute for the user's particular test to run. Receiving a specification may include communicating via an API that accepts the prompt and the iteration parameters, such as from user or system input. The iteration parameters identified in the specification or received via the API include a number of response chains (M) to apply as the plurality of response chains and a number of iterations (N) per response chain to apply as the plurality of iterations and may also include the target LM (ƒ_{LM}) to evaluate, a refinement instruction (T), and/or an embedding function to apply. When the specification is a document or in another machine-readable format, the system parses the specification to identify the prompt and the iteration parameters for use during execution.

In an embodiment, the system queries an LM to generate responses to the prompt according to the plurality of iteration parameters (Operation 204). The prompt (P) is the query for an LM whose uncertainty is being quantified by the system executing the operations and is associated with the topic or domain under test. The system may identify the target LM and input the prompt into the LM to query the LM. Identifying the target LM includes detecting the LM whose uncertainty is being quantified by parsing the specification for the LM function (ƒ_{LM}) or the API input for the LM function. Along with inputting the prompt into the LM, the system applies the iteration parameters for the LM execution. Upon inputting the prompt and applying the iteration parameters to the LM, the system executes the LM to generate responses to the prompt according to the iteration parameters. The system issues M independent queries to ƒ_{LM} with prompt P to obtain the initial responses,

$${r}_{i}^{( 0 )} ∈ \{ 1 , ... , M \} .$$

For example, if the iteration parameters include a number of response chains (M) parameter equal to ten response chains, then ten responses to the prompt are generated. In some embodiments, the specification includes a plurality of prompts, and the system selects a prompt from among the plurality of prompts to query the LM. For instance, the system can select from among multiple topics or domains to test, or a seed prompt can generate diverse variants (e.g., “Create 10 distinct questions . . . ” with output in JSON) for topic-set creation to stress-test response stability across nuanced framings.

In an embodiment, the system initializes a response chain for each response in the responses to the prompt to generate a plurality of response chains (Operation 206). The system applies the iteration parameters for the LM execution to initialize a number of response chains (M) identified in the iteration parameters for the responses generated by the LM with the prompt as input. For example, if the iteration parameters include a number of response chains (M) parameter equal to ten response chains, then ten responses to the prompt are generated, and ten response chains are initialized for those responses. To generate the response chains, the system initializes M response chains,

$${r}_{1}^{( 0 )} , {r}_{2}^{( 0 )} , ... , {r}_{M}^{( 0 )}$$

from the initial responses,

$${r}_{i}^{( 0 )} ∈ \{ 1 , ... , M \} ,$$

generated by querying ƒ_{LM}(P). In the analogy to a MCMC method, the system treats each response as a chain “walker” in the response space where the initial batch of M responses generated by the LM corresponds to independent response chain “walkers” in a response space, each starting from an over dispersed initialization. Additionally, the system can treat the initial conditions as the random samples for MCMC.

In an embodiment, the system performs, for each response chain of the plurality of response chains, a plurality of iterations according to the plurality of iteration parameters to generate a plurality of refined response chains (Operation 208). In an MCMC method, after starting at the initial point, a new state is proposed based on the current state. In the analogy between MCMC sampling and iteratively prompting an LM, after the initial response chains are generated by the LM, a subsequent “think more” or refinement step in the LM prompting acts as a proposal mechanism to generate new responses conditioned on the current state.

In particular, for each iteration of the plurality of iterations, the system queries the LM with the immediately prior response in the response chain for the current iteration along with a refinement instruction (T) acting as a “think more” prompt that provokes further elaboration of the immediately prior response in the response chain. Each iteration produces a plurality of new responses for the response chain in that iteration. The proposal mechanism is the refinement instruction (T) acting as a proposal function, where for each walker i at step t, the LM generates a new response:

$${r}_{i}^{( t + 1 )} = {f}_{LM} ( {r}_{i}^{( t )} , T ) ,$$

where

$${r}_{i}^{( t )}$$

represents the current response of walker i, and

$${f}_{LM} ( {r}_{i}^{( t )} , T )$$

represents the LM generating a new response conditioned on the current state. The plurality of iterations is identified by the system from the iteration parameters as the number of iterations (N) to apply per response chain. The system can also find the refinement instruction (T) in the iteration parameters or the specification in some embodiments.

The system performs the plurality of iterations for each response chain of the plurality of response chains (i.e., for each iteration t from 1 to N and for each chain i in M) to generate the plurality of refined response chains. The iterations are performed for each of the response chains, so the system generates new responses for each response chain i in {1, . . . , M} for t=1 to N:

$${r}_{i}^{( t )} = {f}_{LM} ( {r}_{i}^{( t - 1 )} , T ) , {∀}_{i} ∈ \{ 1 , … , M \} .$$

Repeatedly applying the “think more” refinement to each response chain refines the responses in each response chain, resulting in a plurality of refined response chains. The refined response chains

$$( {r}_{i}^{( t )} )$$

include the new responses produced for the response chains during the iterations. For example, if the iteration parameters include a number of response chains (M) parameter equal to ten response chains and a number of iterations (N) parameter equal to five iterations, then ten responses to the prompt are initially generated, ten response chains are initialized for those responses, and five iterations are performed for each of the ten response chains to result in 50 refined response chains being generated. Thus, iteratively prompting the LM to “think more” allows for exploring the response space of the LM and facilitating the analysis of response-space exploration over time. The generated new responses are retained without acceptance-rejection filtering, and the system associates the plurality of refined response chains in storage such as in a data repository in the system.

In an embodiment, the system transforms each refined response chain of the plurality of refined response chains into a vector representation in an embedding space to generate a plurality of vector representations (Operation 210). The system may convert the refined response chains to embeddings to transform each refined response chain of the plurality of refined response chains into a vector representation in an embedding space. The refined response chains include the new responses

$$( {r}_{i}^{( t )} )$$

generated when the system performed the plurality of iterations, so the system converts the new responses to embeddings to transform the refined response chains. Converting the new responses to embeddings includes computing embeddings

$${e}_{i}^{( t )}$$

for the new responses

$${r}_{i}^{( t )} .$$

The system applies an embedding function (e.g., SentenceTransformer to compute the embeddings for the new responses, thereby embedding the new responses in the embedding space. The system receives the embedding function as an input, such as via the specification or API, prior to using the embedding function to embed the new responses. In some embodiments, transforming the refined response chains into vectors in the embedding space includes generating sentence-level embeddings in the embedding space. The embeddings are vector representations of the refined response chains that capture semantic relationships in the new responses generated when the system performed the plurality of iterations. Therefore, the system generates a plurality of vector representations when the refined response chains are transformed.

In some embodiments, the system stores the refined response chains in storage such as in a data repository in the system. To transform the refined response chains into the vector representations in the embedding space, the system accesses the storage that includes the refined response chains, retrieves the refined response chains from the storage, generates a vector for each refined response chain to generate a plurality of vectors, and stores the plurality of vectors in the embedding space.

In an embodiment, based on the plurality of vector representations, the system computes a plurality of between-chain variances between the plurality of refined response chains and a plurality of within-chain variances within each refined response chain of the plurality of refined response chains (Operation 212). The system can leverage the vector representations (i.e., the embeddings converted from the refined response chains) and cosine similarity to operationalize semantic variance measurements across and within response chains. In particular, the system computes variance metrics at each iteration t of the plurality of iterations. The variance metrics include between-chain variances and within-chain variances. The system may track both between-chain and within-chain variance via cosine similarity over iterations. In some embodiments, the between-chain variances (B^{(t)}) and the within-chain variances (W^{(t)}) are stored in storage, such as in a data repository in the system, for analysis.

The between-chain variances are computations of the cosine distance between embeddings

$${e}_{i}^{( t )} , {e}_{j}^{( t )} ,$$

where i≠j. A between-chain variance may be the pairwise cosine-distance variance across the response chains, the system computing the between-chain dispersion value at iteration t by computing an average of squared pairwise dissimilarities across vector representations of the M response chains at iteration t. Computing the between-chain variances between the refined response chains includes computing between-chain variances as a function of pairwise dissimilarities among the vector representations at each iteration of the plurality of iterations. The system can calculate the between-chain variance (B) at iteration t using cosine similarity:

$${B}^{( t )} = \frac{1}{M ( M - 1 )} {\sum }_{i \neq j} {( 1 - cos ( {e}_{i}^{( t )} , {e}_{j}^{( t )} ) )}^{2}$$

to compute the plurality of between-chain variances (B^{(t)}) between the plurality of refined response chains based on the plurality of vector representations.

The within-chain variances are computations of the pairwise distances across a response chain's trajectory up to iteration t for each response chain i in M, where the response chains are represented in the embeddings

$${e}_{i}^{( k )} , {e}_{i}^{( l )} ,$$

where k≠l. A within-chain variance may be the cosine-distance variance within each response chain across iterations over time within each response chain, the system computing the within-chain dispersion value at iteration t by, for each response chain, computing an average of squared pairwise dissimilarities across vector representations of responses generated for that response chain up to iteration t, and aggregating said averages across the M response chains. Computing the within-chain variances within each refined response chain includes computing within-chain variances as a function of pairwise dissimilarities within the plurality of vector representations at each iteration of the plurality of iterations and aggregated across the plurality of refined response chains. The system can calculate within-chain variance (W) at iteration i using cosine similarity:

$${W}^{( t )} = \frac{1}{M} {\sum }_{i = 1}^{M} \frac{1}{t ( t - 1 )} {\sum }_{k \neq l} {( 1 - cos ( {e}_{i}^{( k )} , {e}_{i}^{( l )} , ) )}^{2}$$

to compute the plurality of within-chain variances (W^{(t)}) within each refined response chain of the plurality of refined response chains based on the plurality of vector representations.

In an embodiment, the system generates a convergence metric based on the plurality of between-chain variances and the plurality of within-chain variances (Operation 214). The system may perform calculations using one or more formulas with the between-chain variances and the within-chain variances as inputs to generate the convergence metric. Computing the between-chain variances and the within-chain variances for M response chains and N iterations per response chain, the convergence metric is indicative of the stability of the response chains over the iterations. In an embodiment, the calculations for generating the convergence metric are performed using the Gelman-Rubin convergence diagnostic. The Gelman-Rubin diagnostic assesses convergence by evaluating if multiple response chains have converged to the same stationary distribution by comparing the within-chain variance to the between-chain variance. To generate the convergence metric using the Gelman-Rubin diagnostic, the within-chain variance (W) is the average variability within each chain, defined as:

$$W = \frac{1}{m} {\sum }_{j = 1}^{m} {s}_{j}^{2} ,$$

where

$${s}_{j}^{2}$$

is the sample variance of chain j, and the between-chain variance (B) is the variability of chain means, scaled by the number of samples per chain:

$$B = \frac{n}{m - 1} {\sum }_{j = 1}^{m} {( {\overline{θ}}_{j} - {\overline{θ}}_{overall} )}^{2} .$$

To generate the convergence metric based on the between-chain variances and the within-chain variances, the system computes a combination of the between-chain variances combined with the within-chain variances to judge convergence of the response chains. In an embodiment, the system computes a pooled variance (\hat{V}) as the combination of the between-chain variances combined with the within-chain variances as follows:

$$\hat{V} = \frac{n - 1}{n} W + \frac{1}{n} B .$$

In an embodiment using the Gelman-Rubin diagnostic, the system generates the convergence metric (\hat{R}) as:

$$\hat{R} = \sqrt{\frac{\hat{V}}{W}} .$$

By examining the evolution of the variance within and across the response chains, the system can analyze the reasoning behavior of the LM. For instance, when the LM is prompted on ambiguous or unfamiliar topics, the variance may increase across iterations to reflect diverse exploration without convergence, whereas prompting the LM with familiar topics results in a variance decrease as responses converge to reflect the confidence and stability in the reasoning of the LM.

In an embodiment, the system compares the convergence metric to at least one threshold to determine a convergence state of the plurality of response chains (Operation 216). The system may access a storage device to identify at least one threshold to compare with the convergence metric to determine the convergence state of the response chains. To compare the convergence metric to the at least one threshold to determine the convergence state of the response chains, the system classifies responses in the response chains as converged when the convergence metric satisfies a threshold indicative of stability of the responses or classifies responses in the response chains as non-converged when the convergence metric exceeds a threshold value. The convergence metric may indicate stability of the response chains over the iterations when the convergence metric meets a threshold value, so the system determines the convergence state of the response chains as converged when the convergence metric meets a threshold value. The convergence metric may indicate instability of the response chains over the iterations when the convergence metric exceeds a threshold value, so the system determines the convergence state of the response chains as non-converged when the convergence metric exceeds a threshold value.

In an embodiment, the system uses the Gelman-Rubin diagnostic (\hat{R}) as the convergence metric to provide insights into the diversity and convergence of responses when applied to LM outputs. In particular, the system compares the convergence metric to thresholds of 1 and 1.1, where a converged convergence state is determined when \hat{R}≈1 and non-converged convergence state is determined when \hat{R}>1.1. The converged convergence state indicates the responses are consistent and reliable LM outputs, and the non-converged convergence state indicates a lack of convergence of the responses and need for additional iterations of the LM or refinement in the LM prompting. By explicitly measuring variances both across and within response trajectories and computing a convergence metric (\hat{R}), the system provides a rigorous, quantitative convergence signal in the convergence state, thereby addressing the lack of reliable uncertainty assessment in prior consistency techniques and providing complementary signals of convergence or instability.

In an embodiment, the system generates a reliability indicator for the LM based on the convergence state (Operation 218). The system may interpret the convergence state to generate a reliability indicator for the LM. Interpreting the convergence state includes analyzing the trends of B^{(t)} and W^{(t)} to assess convergence of the response chains. The reliability indicator may include a time series of the between-chain variances, within-chain variances, and convergence metric. For instance, the system may determine the LM is reliable for familiar or well-understood topics when the variances tend to decrease or determine the LM is unreliable for ambiguous or poorly known topics when the variances remain high or increase. The reliability indicator may include a convergence label or a domain trust profile associating the prompt with a reliability classification based on the convergence metric and the convergence state. Interpreting the convergence state also includes the system identifying the convergence state of the response chains as converged or non-converged and determining the reliability of the LM based on the convergence state. For instance, the system may determine the LM is reliable for familiar or well-understood topics when the convergence state is converged (i.e., the response chains converge) or determine the LM is unreliable for ambiguous or poorly known topics when the convergence state is non-converged (i.e., the response chains diverge). When the convergence state is converged, the system can generate a reliability indicator in the form of a message or log entry stating the LM is reliable for the particular inputs and responses. When the convergence state is non-converged, the system signals the need for safeguards for the LM by generating a reliability indicator stating the LM is unreliable and further tuning is needed. Safeguards that may be implemented include human oversight, external verification, or retrieval augmentation in production use, as non-limited examples. The system initiates some safeguard actions automatically when the convergence state is non-converged, such as routing the prompt for a review process, deferring outputs from the LM, or invoking retrieval-augmented generation (RAG) for subsequent inference. In some embodiments, the system may include a suggested safeguard in the reliability indicator. Domain-specific trust profiles distinguish reliable topics from risky topics for the LM and guide the safeguards prior to deployment. The system uses trends in B^{(t)}, W^{(t)}, and \hat{R} to build a domain-specific trust profile that identifies topics or domains where the LM converges and is therefore trustworthy or where the LM diverges and is therefore risky. To build a domain-specific trust profile, the system may map the prompts or topics tested to one or more reliability classifications derived from the convergence state and the convergence metric. The system may store the domain-specific trust profile in a storage device for the system for subsequent retrieval for the gating of LM deployment decisions.

In an embodiment, the system outputs the reliability indicator to a machine-readable data structure (Operation 220). The system can store the reliability indicator (e.g., the domain trust profile) in a database or other indexed structure for storage. For instance, the system may output the reliability indicator to a log, and the log may be stored in a storage device for redundancy. The system may format the reliability indicator into a structured response (e.g., the convergence state and/or the time series metrics in a JSON format) and output the structured response via the API. The system can generate a time-series artifact by storing, in association with the prompt, a time series of the between-chain variances, the within-chain variances, and the convergence metric over the iterations, and the system can export the time series artifact in the machine-readable format. The system may output the reliability indicator to an interface for the user to be notified of the reliability of the LM. In embodiments where the specification includes a plurality of prompts, the system executes the operations for each prompt of the plurality of prompts and produces and outputs a corresponding reliability indicator for each prompt.

### 4. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

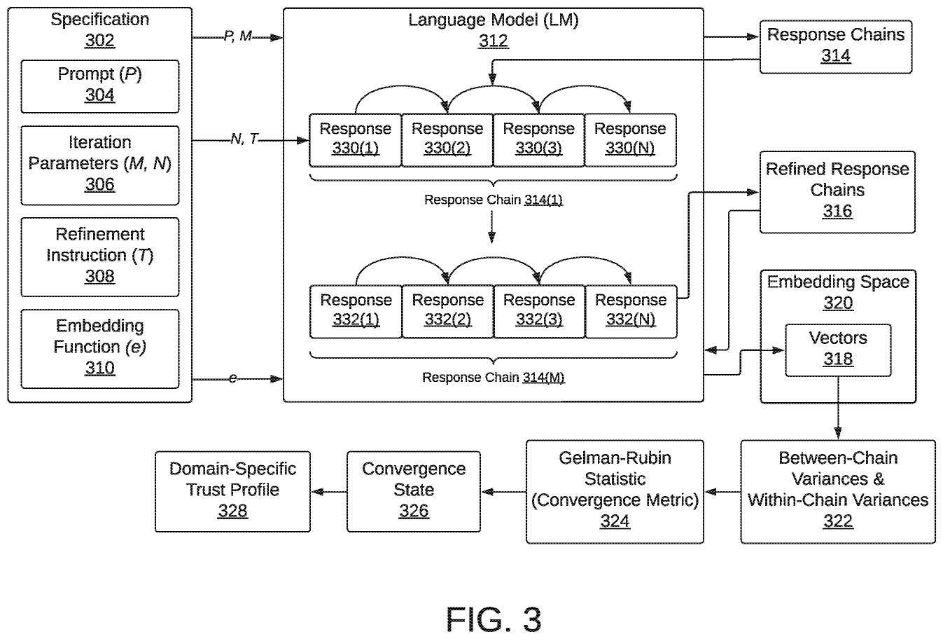

FIG. 3 illustrates quantifying uncertainty in LMs in accordance with one or more embodiments. Language models have many capabilities across a wide range of tasks, from answering questions to generating creative content. Reasoning tasks may be problematic for LMs, especially in scenarios with ambiguities, incomplete knowledge, or complex chains of logic, due to an LM's probabilistic generation of responses that leverage patterns in training data rather than structured reasoning processes. Uncertainty quantification is a critical aspect of addressing these challenges, as it enables robust assessment of model outputs and enhances model reliability in diverse applications.

Markov Chain Monte Carlo (MCMC) methods construct Markov chains that converge to a target distribution to enable efficient sampling from complex spaces, and convergence diagnostics, such as the Gelman-Rubin statistic, can be used to evaluate if chains have mixed well and provide reliable estimates of the target distribution. An analogy can be drawn between the iterative nature of LM prompting and MCMC methods, allowing tools used for probabilistic modeling, such as the Gelman-Rubin statistic, to be applied to analyzing and quantifying uncertainty in LM responses. In the present disclosure, the variance-based metrics from MCMC diagnostics are applied to LM responses to analyze the dynamics of the LM responses by employing a systematic framework for evaluating the stability and reliability of the LM outputs. In the example of FIG. 3, the quality and consistency of LM outputs are evaluated using iterative prompting to quantify uncertainty in the LM.

In some embodiments, the Metropolis-Hastings algorithm can be applied as the MCMC method. The Metropolis-Hastings algorithm is an MCMC method designed to sample from a posterior distribution P(θ|data), defined by Bayes' theorem as P(θ|data)∝P(data|θ)P(θ), where P(data|θ) is the likelihood and P(θ) is the prior. The Metropolis-Hastings algorithm constructs a Markov chain with the target posterior as its stationary distribution through the following iterative process:
1. Initialization: Start the Markov chain at an initial value θ₀
2. Proposal and Update: At each iteration t=1, 2, . . . , T:
   a. Propose: Sample a candidate value θ* from a proposal distribution q(θ*|θₜ)
   b. Acceptance Ratio: Compute the acceptance ratio:

$$α = min ( 1 , \frac{P ( data \vert {θ}^{*} ) P ( {θ}^{*} ) q ( {θ}_{t} \vert {θ}^{*} )}{P ( data \vert {θ}_{t} ) P ( {θ}_{t} ) q ( {θ}^{*} \vert {θ}_{t} )} )$$

c. Accept or Reject: Draw u~ [symbol] (0,1). If u<α, accept θ* and set θₜ₊₁=θ*; otherwise, set θₜ₊₁=θₜ.

The analogy between MCMC sampling and iteratively prompting an LM includes the initial batch of responses generated by the LM corresponding to independent response chains, each starting from an over dispersed initialization and a subsequent “think more” or refinement step in the LM prompting acting as a proposal mechanism to generate new responses conditioned on the current state. By examining the evolution of the variance within and across the response chains, the reasoning behavior of the LM can be analyzed by the system. For instance, when the LM is prompted on ambiguous or unfamiliar topics, the variance may increase across iterations to reflect diverse exploration without convergence, whereas prompting the LM with familiar topics results in a variance decrease as responses converge to reflect the confidence and stability in the reasoning of the LM.

Iteratively prompting the LM to “think more” introduces an iterative process for exploring the response space of the LM. In analogizing the iterative prompting of the LM to an MCMC method, the initial batch of M responses generated by the LM corresponds to independent walkers in a response space, and the iterative application of the “think more” prompt serves as a proposal mechanism. Each response in the M initial responses is a walker starting at a unique position in the response space due to differences in the initial prompts. The proposal mechanism is a “think more” prompt acting as a proposal function, where for each walker i at step t, the LM generates a new response:

$${r}_{i}^{( t + 1 )} = {f}_{L M} ( {r}_{i}^{( t )} , think more ) ,$$

where

$${r}_{i}^{( t )}$$

represents the current response of walker i, and ƒ_{LM}

$${r}_{i}^{( t )} ,$$

“think more”) represents the LM generating a new response conditioned on the current state. Unlike traditional MCMC, which uses an acceptance-rejection step to maintain detailed balance, this process accepts the proposed responses. As a result, the process is analogous to a random walk where every step is retained.

In an embodiment, the system accesses a specification 302 that includes a prompt (P) 304, iteration parameters 306 that include a number of response chains (M) and a number of iterations (N) per response chain, a refinement instruction (T) 308 acting as a “think more prompt” for the target LM being evaluated, and an embedding function (e) 310. The system queries a language model 312 to generate responses to the prompt 304 according to the prompt 304 and the number of response chains (M) identified in the iteration parameters 306. The language model 312 is the target model whose uncertainty is being quantified and is associated with the domain under test. The prompt 304 is input into the language model 312, and a response chain is initialized for each of the responses to the prompt 304 to generate a plurality of response chains 314 when the language model 312 is executed with the iteration parameters 306.

The response space is then explored. The embeddings of the M responses are computed at each step, and the variance of cosine similarity among these embeddings is measured. The variance of cosine similarity is a diagnostic or metric for how the response space is being explored and determines whether the responses are converging or diverging.

The system performs, for each response chain of the response chains 314, a plurality of iterations according to the number of iterations (N) in the iteration parameters 306 and the refinement instruction (T) 308 to generate refined response chains 316. After the initial response chains 314 are generated by the language model 312, a subsequent “think more” step in the language model 312 prompting acts as a proposal mechanism to generate new responses conditioned on the current state. The “think more” prompting of the language model 312 is guided by the refinement instruction 308. Performing the iterations includes querying, for each of the iterations (N) and for each of the response chains (M) 314 (i.e., for each iteration t from 1 to Nand for each chain i in M), the language model 312 with an immediately prior response in the response chain and the refinement instruction 308 to produce new responses for the response chain. For instance, the iterations (N) are performed for the first response chain 314(1) to produce new responses 330. During the iterations for the first response chain 314(1), the language model 312 is queried with the refinement instruction 308 and the immediately prior response in the response chain, such as querying with response 330(1) in the second iteration, response 330(2) in the third iteration, response 330(3) in the fourth iteration, and so on until response 330(N) is produced. Next, the iterations (N) are performed for the next response chain to produce new responses until all the response chains 314 are iterated on. For instance, during the iterations for the final response chain 314(M), the language model 312 is queried with the refinement instruction 308 and the immediately prior response in the response chain, such as querying with response 332(1) in the second iteration, response 332(2) in the third iteration, response 332(3) in the fourth iteration, and so on until response 332(N) is produced. As a result, the refined response chains 316 include the new responses. The system transforms each of the refined response chains 316 into a vector representation in an embedding space 320 by generating a vector for each refined response chain using the embedding function (e) 310, resulting in vectors 318 that are stored in the embedding space 320. The embedding function 310 computes the embeddings for the new responses, thereby embedding the new responses in the embedding space 320.

The system computes variances 322 based on the vectors 318, including between-chain variances between the refined response chains 316 and within-chain variances within each of the refined response chains 316. The variances 322 are computed at each iteration t of the iterations (N). The system generates a convergence metric 324 based on the between-chain variances and the within-chain variances by computing a combination of the between-chain variances with the within-chain variances and calculating a Gelman-Rubin statistic based on the combination. The system uses the Gelman-Rubin statistic as the convergence metric 324 to provide insights into the diversity and convergence of the responses when applied to the language model 312 outputs. The system compares the convergence metric 324 to at least one threshold to determine a convergence state 326 of the response chains 314. The responses in the response chains 314 are classified as converged when the convergence metric 324 satisfies the at least one threshold to indicate stability of the responses and a converged conversion state 326. The responses in the response chains 314 are classified as non-converged when the convergence metric 324 exceeds the at least one threshold to indicate instability of the responses and a non-converged conversion state 326.

The Gelman-Rubin statistic is a method for assessing the convergence of MCMC simulations by evaluating if multiple chains, initialized from over dispersed starting points, have converged to the same stationary distribution by comparing within-chain variance to between-chain variance. The within-chain variance (W) is the average variability within each chain, defined as:

$$W = \frac{1}{m} {\sum }_{j = 1}^{m} {s}_{j}^{2} ,$$

where

$${s}_{j}^{2}$$

is the sample variance of chain j. The between-chain variance (B) is the variability of chain means, scaled by the number of samples per chain:

$$B = \frac{n}{m - 1} {\sum }_{j = 1}^{m} {( {\overline{θ}}_{j} - {\overline{θ}}_{overall} )}^{2} .$$

The pooled variance (\hat{V}) combines the within-chain variance and the between-chain variance components as follows:

$$\hat{V} = \frac{n - 1}{n} W + \frac{1}{n} B .$$

The Gelman-Rubin statistic (\hat{R}) is computed as:

$$\hat{R} = \sqrt{\frac{\hat{V}}{W}} .$$

When applied to LM outputs, the Gelman-Rubin statistic (\hat{R}) provides insights into the diversity and convergence of responses, as \hat{R}≈1 indicates convergence (i.e., stable and consistent responses), and \hat{R}>1.1 indicates a lack of convergence (i.e., variable and inconsistent responses). Convergence suggests consistent and reliable LM outputs, and a lack of convergence indicates a need for additional iterations of the LM or refinement in the LM prompting.

The system generates a reliability indicator for the language model 312 based on the convergence state 326. The system may interpret the convergence state 326 to generate a reliability indicator for the language model 312. Interpreting the convergence state 326 includes analyzing the trends of the variances 322 to assess convergence of the response chains 314, as the language model 312 is reliable for familiar topics when the variances 322 tend to decrease or unreliable for poorly known topics when the variances 322 remain high or increase. The system identifies the convergence state 326 of the response chains 314 as converged or non-converged and determines the reliability of the language model 312 based on the convergence state 326. In the example of FIG. 3, the reliability indicator is a domain trust profile 328 associating the prompt 304 with a reliability classification based on the convergence metric 324 and the convergence state 326. To build a domain trust profile 328, the system can map the prompt 304 tested to one or more reliability classifications derived from the convergence state 326 and the convergence metric 324. The system outputs the domain trust profile 328, so a safeguard action can be initiated when the convergence state 326 is non-converged. For converged response chains 314, the system proceeds with fewer safeguards, but for non-converged response chains 314, the system adds controls, such as human oversight, external verification, or RAG, logs the convergence state 326 in the system, and communicates the uncertainty to users via an interface. The domain trust profile 328 distinguishes reliable topics from risky topics for the language model 312 and guides the safeguards prior to deployment. In particular, the domain trust profile 328 identifies domains where the language model 312 converges and is therefore trustworthy, or the domain trust profile 328 identifies domains where the language model 312 diverges and is therefore risky.

In an embodiment, the iterative prompting and variance analysis for LM response reliability uses cosine similarity as follows:
1. Input: Prompt P, number of response chains M, number of iterations N, LM function ƒ_{LM}, and “think more” prompt T.
2. Output: Trends in the within-chain variance (W) and the between-chain variance (B):
   a. Initialize M response chains,

$${r}_{1}^{( 0 )} , {r}_{2}^{( 0 )} , … , {r}_{M}^{( 0 )}$$

by querying ƒ_{LM}(P)
b. Generate new responses for each response chain for t=1 to N:

$${r}_{i}^{( t )} = {f}_{L M} ( {r}_{i}^{( t - 1 )} , T ) , {∀}_{i} ∈ \{ 1 , … , M \}$$

c. Compute embeddings

$${e}_{i}^{( t )}$$

for all of the new responses

$${r}_{i}^{( t )}$$

d. Calculate between-chain variance (B) at iteration t using cosine similarity:

$${B}^{( t )} = \frac{1}{M ( M - 1 )} {\sum }_{i \neq j} {( 1 - cos ( {e}_{i}^{( t )} , {e}_{j}^{( t )} ) )}^{2}$$

e. Calculate within-chain variance (W) at iteration t using cosine similarity:

$${W}^{( t )} = \frac{1}{M} {\sum }_{i = 1}^{M} \frac{1}{t ( t - 1 )} {\sum }_{k \neq l} {( 1 - cos ( {e}_{i}^{( k )} , {e}_{i}^{( l )} ) )}^{2}$$

f. Store B^{(t)} and W^{(t)} for analysis
g. Analyze trends of B^{(t)} and W^{(t)} to assess convergence.

Deeper insights into the LM's knowledge and certainty about a given topic are gained by analyzing how both the within-chain variance and the between-chain variance evolve during the iterative prompting process. For instance, an LM may be asked about a niche or ambiguous topic the LM does not know much about. In this case, the between-chain variance among the M responses may initially be high and continue to increase as the LM explores diverse interpretations or possibilities. Simultaneously, the within-chain variance may also remain high, reflecting instability within the individual response trajectories. Such behavior highlights the LM's lack of convergence and tendency to generate diverse outputs when uncertain. In contrast, if the LM is asked about a well-known subject or a topic that the LM has a solid understanding of, then both the between-chain variance and the within-chain variance are expected to decrease over iterations. Even if the initial batch of M responses is prompted in a different manner to encourage variability, the iterative “think more” process leads to convergence, and the responses stabilize both within and across chains.

In an example, asking the LM about unfamiliar or speculative topics, such as “What would an alien society's legal system look like?” may result in increasingly diverse answers (i.e., high between-chain variance) and unstable trajectories within each chain (i.e., high within-chain variance). Alternatively, asking the LM about familiar or well-established topics, such as “What are the fundamental principles of thermodynamics?” leads to responses that converge over iterations (i.e., low between-chain variance) and stabilize within individual trajectories (i.e., low within-chain variance). This difference between prompting an LM with unfamiliar topics versus familiar topics illustrates the importance of combining both the between-chain variance and the within-chain variance to produce robust diagnostics. For instance, without accounting for within-chain variance, a decreasing between-chain variance could misleadingly suggest convergence even though individual response chains are unstable or diverging internally. By combining both the between-chain variance and the within-chain variance, a comprehensive framework is provided to assess an LM's certainty and understanding of various topics.

To assess the stability of responses generated by an LM, the Gelman-Rubin convergence metric can be used to evaluate variability across multiple iterative response chains. The response chains are constructed by prompting the LM with an instruction to generate a diverse set of questions, such as the following example prompt input to the LM: “Create 10 distinct questions exploring whether artificial intelligence (AI) should have rights similar to humans. Each question should be framed to subtly suggest a different response as the most reasonable or expected answer | either in favor, against, strongly in favor, strongly against, or neutral. Output the questions in JSON format, where the keys are ‘question 1’, ‘question 2’, etc., and the values have the full text of each question. Ensure all ten questions are provided.” The LM's responses to each question can be iteratively refined and the process repeated until there are ten responses per question. To quantify the within-chain variance and the between-chain variance, the cosine similarity between response embeddings can be computed such as by using a transformer model. Based on the cosine similarity computations producing the within-chain variance and the between-chain variance metrics, stability of the LM is determined. If the LM is not producing stable, consistent responses, then the LM may need more iterative refinements to stabilize. This result has important implications for applications where response consistency and efficiency are critical.

### 5. Machine Learning Architecture

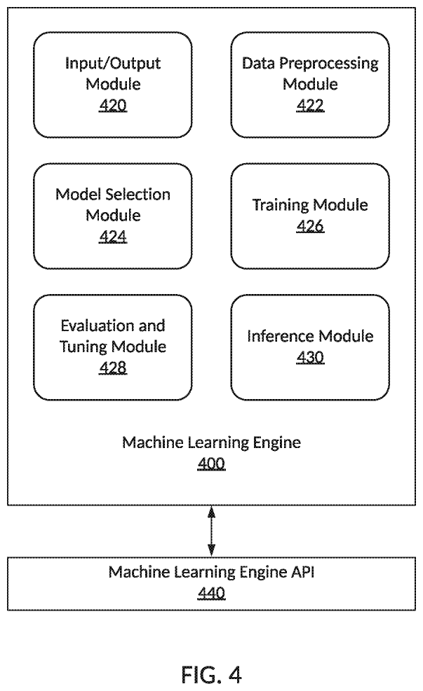

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

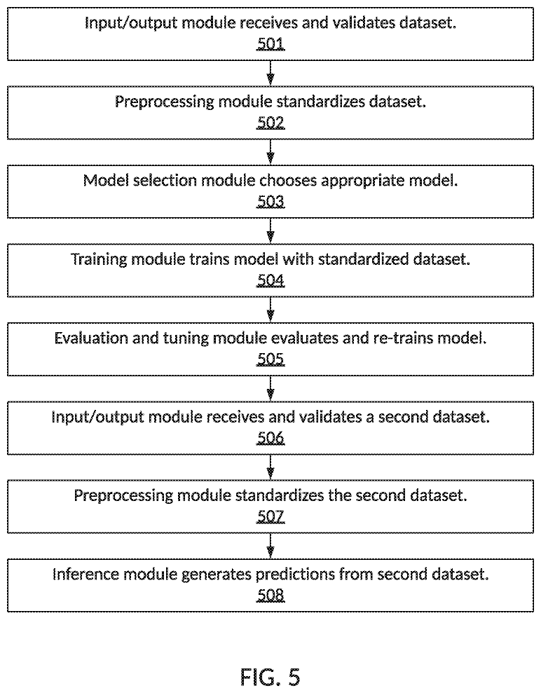

FIG. 5 illustrates the operation of a machine learning engine in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 6. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model (LLM). Large language models (LLMs) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 420, when used for LLMs, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 422 in the context of LLMs may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 424, when used for LLMs involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 426, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 428 assesses the performance of LLMs using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 430, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models (LMMs) learn to create coherent and contextually relevant outputs across various modalities, enhancing their utility in complex, real-world scenarios.

The architecture of LMMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

LMMs represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. Practical Applications, Advantages, and Improvements

Embodiments provide several practical applications, advantages, and improvements over existing approaches. These advantages and improvements include the ability to provide insights into the confidence and trustworthiness of an LM in various subject areas, such as confidence in specific or well-known domains (e.g., basic arithmetic or widely available factual knowledge) and uncertainty in ambiguous or poorly known domains (e.g., niche scientific topics or speculative questions). For example, if the variance across responses decreases with iterative prompting and the responses converge to a stable state, the LM can be denoted as confident and reliable in that domain, whereas the responses are unstable and the LM lacks confidence or knowledge in that domain if the variance remains high or increases over iterations. Additionally, using the offline iterative process for testing LMs allows practitioners to build a domain-specific trust profile for an LM by testing the model across a wide range of topics and systematically and clearly identifying areas where the LM converges or diverges. The LM can then be classified as trustworthy in domains where convergence and stability are observed or as untrustworthy or risky in domains where divergence or instability persist. For domains marked as untrustworthy, additional safeguards, such as human oversight, external verification, or hybrid reasoning systems (e.g., RAG) may be necessary. As an offline benchmarking tool, enterprises can evaluate LM response stability systematically across topics, domains, and models prior to real-time use, which complements production inference modules that interpret and communicate uncertainty to users and acknowledges computational cost while enabling policy and governance decisions before real-time use. These advantages and improvements yield a more reliable determination of certainty versus exploration for the LM under test. Limitations of prior consistency methods (e.g., self-consistency, CoT, ReAct, Self-Refine, ToT) that lack formal convergence tests are overcome by the advantages and improvements of the embodiments of the present disclosure.

Embodiments provide rigorous, quantitative diagnostics rather than heuristic voting of existing approaches by explicitly measuring variances across and within LM response trajectories and computing a convergence metric as a quantitative convergence signal. This addresses the lack of reliable uncertainty assessment in prior consistency techniques.

Embodiments compute within-chain variances and between-chain variances from embeddings and aggregate the variances via a convergence metric, such as the Gelman-Rubin statistic, to objectively assess convergence and uncertainty of LM responses. This results in improved diagnostics by providing a clear quantification of LM uncertainty.

Embodiments detect misleading agreement by jointly analyzing the within-chain variances and the between-chain variances, which avoids false signals of stability that can arise if simply cross-sample agreement is considered.

Embodiments provide insights into the confidence and trustworthiness of an LM in various domains by systematically differentiating reliable domains from risky domains prior to real-time use. Reliable domains are differentiated from risky domains by analyzing variance trends and thresholds to generate domain-specific trust profiles that identify when the LM is confident (e.g., domain topics are familiar) versus uncertain (e.g., domain topics are ambiguous or poorly known) to guide appropriate safeguards prior to LM deployment (e.g., the LM is trustworthy when the responses converge or risky when the responses diverge).

Embodiments operate offline to evaluate stability across topics and LMs prior to real-time use to enable informed decisions about oversight, external verification, or retrieval augmentation where needed prior to LM deployment. These practical diagnostics before production allow users to evaluate LM response stability prior to real-time use by interpreting and communicating uncertainty to users.

Embodiments implementing integration of the uncertainty quantification method ensure operational readiness by allowing the method to be plugged into an ML engine with standardized data I/O validation, consistent preprocessing across training and inference, uncertainty-aware inference handling, secure output distribution, and flexible APIs (e.g., REST, SOAP, WebSocket), thereby facilitating compliant, scalable deployment of LMs in enterprise workflows.

Embodiments provide a technical benefit by allowing for implementation of the algorithm using smaller models, resulting in a more efficient algorithm for quantifying LM uncertainty using iterative prompting.

The data input to any ML model and/or the data output from any ML model, as described herein, may be used for operations performed by one or more of the following: Database Software, Cloud Infrastructure Software, Customer Relationship Management Software, Data Science Software, Digital Assistant Software, Vision Software, Language Software, Speech Software, Forecasting Software, Enterprise Software, Middleware, Server Software, Identity Management Software, Application Development Software, Analytics Software, Security Software, Data Integration Software, Health Software, Hospitality Software, Retail Software, Utilities Software, Operating Systems, Virtualization Software, Governance and Administration Software, Migration & Disaster Recovery Software, Networking Software, Connectivity Software, Monitoring Software, Procurement Software, Project Management Software, Risk Management Software, Supply Chain Management Software, Manufacturing Software, Human Capital Management Software, Customer Experience Software, Advertising Software, and Industry-Specific Application Software.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

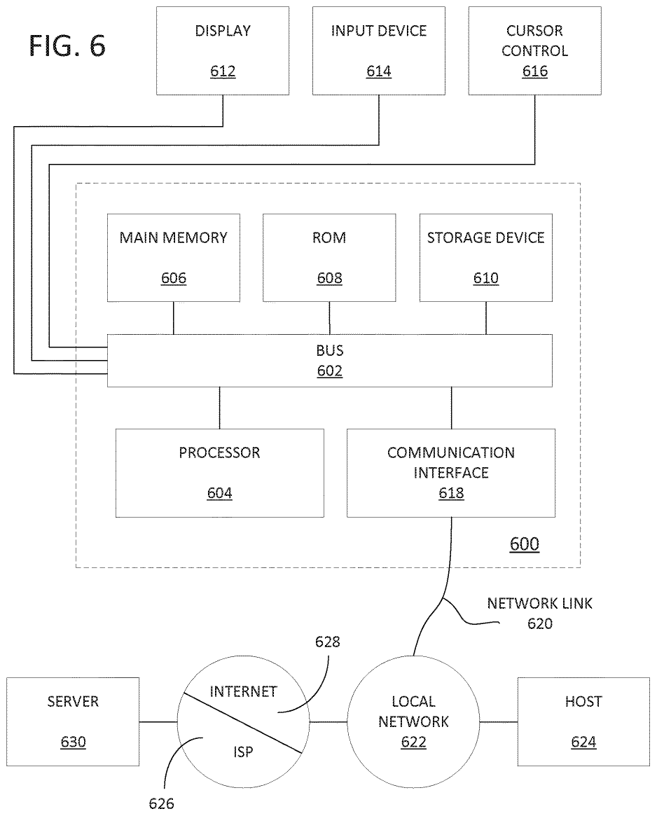

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a solid-state drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infrared data communications.

Various forms of media may be involved in carrying one or more sequences of one or more instructions to processor 604 for execution. For example, the instructions may initially be carried on a magnetic disk or SSD of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector can receive the data carried in the infrared signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
accessing a specification including a prompt and a plurality of iteration parameters;
querying a language model (LM) to generate responses to the prompt according to the plurality of iteration parameters;
initializing a response chain for each response in the responses to the prompt to generate a plurality of response chains;
performing, for each response chain of the plurality of response chains, a plurality of iterations according to the plurality of iteration parameters to generate a plurality of refined response chains;
transforming each refined response chain of the plurality of refined response chains into a vector representation in an embedding space to generate a plurality of vector representations;
computing, based on the plurality of vector representations:
a) a plurality of between-chain variances between the plurality of refined response chains; and
b) a plurality of within-chain variances within each refined response chain of the plurality of refined response chains;
generating a convergence metric based on the plurality of between-chain variances and the plurality of within-chain variances;
comparing the convergence metric to at least one threshold to determine a convergence state of the plurality of response chains;
generating a reliability indicator for the LM based on the convergence state; and
outputting the reliability indicator to a machine-readable data structure;
wherein the method is performed by at least one device including a hardware processor.

2. The method of claim 1, wherein the plurality of iteration parameters includes a number of response chains to apply as the plurality of response chains and a number of refinement iterations to apply as the plurality of iterations.

3. The method of claim 1, wherein the specification includes a plurality of prompts, wherein the prompt comprises a prompt selected from among the plurality of prompts.

4. The method of claim 1, wherein performing, for each response chain of the plurality of response chains, the plurality of iterations according to the plurality of iteration parameters to generate the plurality of refined response chains comprises:
for each response chain of the plurality of response chains: querying, for each iteration of the plurality of iterations, the LM with an immediately prior response in the response chain and a refinement instruction to produce a plurality of new responses for the response chain; and
associating the plurality of refined response chains in storage;
wherein the plurality of refined response chains includes the plurality of new responses produced for each response chain of the plurality of response chains.

5. The method of claim 1, wherein each response chain of the plurality of response chains is independent from other response chains of the plurality of response chains.

6. The method of claim 1, wherein transforming each refined response chain of the plurality of refined response chains into a vector representation in an embedding space to generate the plurality of vector representations comprises:
accessing a storage including the plurality of refined response chains;
retrieving the plurality of refined response chains from the storage;
generating a vector for each refined response chain of the plurality of refined response chains to generate a plurality of vectors; and
storing the plurality of vectors in the embedding space.

7. The method of claim 1, wherein transforming each refined response chain of the plurality of refined response chains into a vector representation in an embedding space to generate the plurality of vector representations comprises generating sentence-level embeddings in the embedding space.

8. The method of claim 1, wherein computing, based on the plurality of vector representations, the plurality of between-chain variances between the plurality of refined response chains, and the plurality of within-chain variances within each refined response chain of the plurality of refined response chains comprises:
computing the plurality of between-chain variances as a function of pairwise dissimilarities among the plurality of vector representations at each iteration of the plurality of iterations; and
computing the plurality of within-chain variances as a function of pairwise dissimilarities within the plurality of vector representations at each iteration of the plurality of iterations and aggregated across the plurality of refined response chains.

9. The method of claim 1, wherein generating the convergence metric based on the plurality of between-chain variances and the plurality of within-chain variances comprises:
computing a combination of the plurality of between-chain variances combined with the plurality of within-chain variances; and
calculating a Gelman-Rubin statistic based on the combination, wherein the convergence metric includes the Gelman-Rubin statistic.

10. The method of claim 1, wherein the convergence metric indicates stability of the plurality of response chains over the plurality of iterations when the convergence metric meets a threshold value.

11. The method of claim 1, wherein the convergence metric indicates instability of the plurality of response chains over the plurality of iterations when the convergence metric exceeds a threshold value.

12. The method of claim 1, wherein the convergence state of the plurality of response chains comprises converged responses in the plurality of response chains or non-converged responses in the plurality of response chains.

13. The method of claim 1, wherein comparing the convergence metric to the at least one threshold to determine the convergence state of the plurality of response chains comprises:
classifying responses in the plurality of response chains as converged when the convergence metric satisfies the at least one threshold, wherein the at least one threshold is indicative of stability of the responses; and
classifying responses in the plurality of response chains as non-converged when the convergence metric exceeds the at least one threshold, wherein the at least one threshold comprises a value greater than 1.1.

14. The method of claim 1, wherein the reliability indicator comprises:
a time series of the plurality of between-chain variances, the plurality of within-chain variances, and the convergence metric,
a convergence label, or
a domain trust profile associating the prompt with a reliability classification based on the convergence metric and the convergence state.

15. The method of claim 1, further comprising:
initiating a safeguard action when the convergence state is non-converged, wherein the safeguard action comprises one or more of routing the prompt for a review process, deferring outputs from the LM, or invoking retrieval-augmented generation for subsequent inference.

16. One or more non-transitory computer-readable media storing program instructions that, when executed by one or more hardware processors, cause performance of operations comprising:
accessing a specification including a prompt and a plurality of iteration parameters;
querying a language model (LM) to generate responses to the prompt according to the plurality of iteration parameters;
initializing a response chain for each response in the responses to the prompt to generate a plurality of response chains;
performing, for each response chain of the plurality of response chains, a plurality of iterations according to the plurality of iteration parameters to generate a plurality of refined response chains;
transforming each refined response chain of the plurality of refined response chains into a vector representation in an embedding space to generate a plurality of vector representations;
computing, based on the plurality of vector representations:
a) a plurality of between-chain variances between the plurality of refined response chains; and
b) a plurality of within-chain variances within each refined response chain of the plurality of refined response chains;
computing a combination of the plurality of between-chain variances combined with the plurality of within-chain variances;
calculating a Gelman-Rubin statistic based on the combination to generate a convergence metric, wherein the convergence metric includes the Gelman-Rubin statistic;
comparing the convergence metric to at least one threshold to determine a convergence state of the plurality of response chains;
generating a reliability indicator for the LM based on the convergence state; and
outputting the reliability indicator to a machine-readable data structure.

17. The one or more non-transitory computer-readable media of claim 16, wherein computing, based on the plurality of vector representations, the plurality of between-chain variances between the plurality of refined response chains, and the plurality of within-chain variances within each refined response chain of the plurality of refined response chains comprises:
computing the plurality of between-chain variances as a function of pairwise dissimilarities among the plurality of vector representations at each iteration of the plurality of iterations; and
computing the plurality of within-chain variances as a function of pairwise dissimilarities within the plurality of vector representations at each iteration of the plurality of iterations and aggregated across the plurality of refined response chains.

18. A system comprising:
one or more hardware processors;
one or more non-transitory computer-readable media; and
program instructions stored on the one or more non-transitory computer-readable media that, when executed by the one or more hardware processors, cause the system to perform operations comprising:
accessing a specification including a prompt and a plurality of iteration parameters;
querying a language model (LM) to generate responses to the prompt according to the plurality of iteration parameters;
initializing a response chain for each response in the responses to the prompt to generate a plurality of response chains;
performing, for each response chain of the plurality of response chains, a plurality of iterations according to the plurality of iteration parameters to generate a plurality of refined response chains, the plurality of iterations including:
for each response chain of the plurality of response chains:
querying, for each iteration of the plurality of iterations, the LM with an immediately prior response in the response chain and a refinement instruction to produce a plurality of new responses for the response chain; and
associating the plurality of refined response chains in storage, wherein the plurality of refined response chains includes the plurality of new responses produced for each response chain of the plurality of response chains;
transforming each refined response chain of the plurality of refined response chains into a vector representation in an embedding space to generate a plurality of vector representations;
computing, based on the plurality of vector representations:
a) a plurality of between-chain variances between the plurality of refined response chains; and
b) a plurality of within-chain variances within each refined response chain of the plurality of refined response chains;
generating a convergence metric based on the plurality of between-chain variances and the plurality of within-chain variances;
comparing the convergence metric to at least one threshold to determine a convergence state of the plurality of response chains;
generating a reliability indicator for the LM based on the convergence state; and
outputting the reliability indicator to a machine-readable data structure.

19. The system of claim 18, wherein transforming each refined response chain of the plurality of refined response chains into a vector representation in an embedding space to generate the plurality of vector representations comprises:
retrieving the plurality of refined response chains from the storage;
generating a vector for each refined response chain of the plurality of refined response chains to generate a plurality of vectors; and
storing the plurality of vectors in the embedding space.

20. The system of claim 18, wherein comparing the convergence metric to the at least one threshold to determine the convergence state of the plurality of response chains comprises:
classifying responses in the plurality of response chains as converged responses when the convergence metric satisfies the at least one threshold, wherein the convergence metric satisfying the at least one threshold indicates stability of the plurality of response chains over the plurality of iterations, wherein the convergence state of the plurality of response chains comprises the converged responses in the plurality of response chains; and
classifying responses in the plurality of response chains as non-converged responses when the convergence metric exceeds the at least one threshold, wherein the convergence metric exceeding the at least one threshold indicates instability of the plurality of response chains over the plurality of iterations, wherein the convergence state of the plurality of response chains comprises the non-converged responses in the plurality of response chains.
